(19) United States
(12) Patent Application Publication
(10) Pub. No.: US 2026/0176961 A1
(43) Pub. Date: Jun. 25, 2026

(54) SYSTEMS AND METHODS FOR IMAGING WHILE DRILLING A BOREHOLE WITH A PLURALITY OF DIFFERENT IMAGE QUALITIES

(71) Applicant: Schlumberger Technology Corporation, Sugar Land, TX (US)

(72) Inventors: Jianguo Liu, Sugar Land, TX (US); Keli Sun, Sugar Land, TX (US); Michael Bower, Sugar Land, TX (US); Xiao Bo Hong, Sugar Land, TX (US); Kent Harms, Sugar Land, TX (US); Yansong Huang, Beijing (CN); Joseph Gremillion, Sugar Land, TX (US); Zhiyi Zhang, Beijing (CN); Xingxian Shou, Sugar Land, TX (US)

(21) Appl. No.: 19/265,217

(22) Filed: Jul. 10, 2025

Related U.S. Application Data
(60) Provisional application No. 63/736,669, filed on Dec. 20, 2024.

(51) Int. Cl. E21B 47/01; E21B 47/002; E21B 47/12

(52) U.S. Cl. CPC E21B 47/01; E21B 47/0025; E21B 47/138

(57) ABSTRACT

A method includes receiving a first set of measurement data from a plurality of transmitter-receiver pairs of a measurement tool coupled to a drill string of a drilling system, wherein the first set of measurement data includes a first portion of measurement data from each of the plurality of transmitter-receiver pairs. The method further includes generating a first inversion image based on the first set of measurement data, updating a geological model based on the first inversion image, and controlling one or more operational parameters of the drilling system substantially in real-time based on the geological model.

### CROSS-REFERENCE TO RELATED APPLICATIONS

This application claims priority to and benefit of U.S. Provisional Patent Application No. 63/736,669, filed on Dec. 20, 2024, which is incorporated by reference herein in its entirety.

### BACKGROUND

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it may be understood that these statements are to be read in this light, and not as admissions of prior art.

Seismic inversion is a widely used technique in drilling for interpreting seismic reflection data to detect and characterize subsurface formations. By applying seismic inversions to drilling data collected during drilling of a borehole, potential deposits, groundwater resources, and other geotechnical features may be better detected. Additionally, by performing seismic inversion while drilling, drilling modifications may be made based on the resulting inversion image to actively shape the drilling of the borehole.

However, current inversion workflows encounter a significant delay in displaying the inversion image, which slows down the ability to make timely drilling modifications based on the image. This delay arises from running an independent forward model for each data point within a capture window, where the system must collect all data points within the window before generating a high-quality inversion image. As such, it may be desirable to develop techniques to take a look at specific data points closer to the front of the drilling equipment and generate a quicker, lower quality inversion image that allows for more immediate drilling decisions to be made without requiring the data from each data point to be received.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In certain embodiments, a method includes receiving a first set of measurement data from a plurality of transmitter-receiver pairs of a measurement tool coupled to a drill string of a drilling system, wherein the first set of measurement data includes a first portion of measurement data from each of the plurality of transmitter-receiver pairs. The method further includes generating a first inversion image based on the first set of measurement data, updating a geological model based on the first inversion image, and controlling one or more operational parameters of the drilling system substantially in real-time based on the geological model.

In certain embodiments, a system includes a computing system having one or more processors, wherein the computing system is communicatively coupled with a drilling system, and a memory storing instructions that, when executed by the computing system, are configured to cause the computing system to perform operations. The operations are configured to receive a first set of measurement data from a plurality of transmitter-receiver pairs of a measurement tool coupled to a drill string of a drilling system, wherein the first set of measurement data includes a first portion of measurement data from each of the plurality of transmitter-receiver pairs. The operations are further configured to generate a first inversion image based on the first set of measurement data, update a geological model based on the first inversion image, and control one or more operational parameters of the drilling system substantially in real-time based on the geological model.

In certain embodiments, a non-transitory, computer readable medium including instructions that, when executed by processing circuitry, cause the processing circuitry to perform operations configured to receive a first set of measurement data from a plurality of transmitter-receiver pairs of a measurement tool coupled to a drill string of a drilling system, wherein the first set of measurement data includes a first portion of measurement data from each of the plurality of transmitter-receiver pairs. The operations are further configured to generate a first inversion image based on the first set of measurement data, update a geological model based on the first inversion image, and control one or more operational parameters of the drilling system substantially in real-time based on the geological model.

The brief summary presented above is intended only to familiarize the reader with certain aspects and contexts of embodiments of the present disclosure without limitation to the claimed subject matter.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 depicts an example wellsite system for measuring borehole data using various downhole tools and surface tools, in accordance with embodiments of the present disclosure;

FIG. 2 depicts a well control system configured to control the wellsite system of FIG. 1, in accordance with embodiments of the present disclosure;

FIG. 3 depicts an example of an electromagnetic logging tool as the logging tool of FIG. 1, in accordance with embodiments of the present disclosure;

FIG. 4 illustrates a method for producing a map of a formation resistivity found between select transmitter-receiver pairs of a subset of a plurality of transmitter-receiver pairs to determine one or more drilling decisions, in accordance with embodiments of the present disclosure;

FIG. 5 illustrates a method for computing a first inversion image as illustrated in FIG. 4, in accordance with embodiments of the present disclosure;

FIG. 6 illustrates an example of window scheming to obtain the first inversion image and the second inversion image as described in FIG. 4, in accordance with embodiments of the present disclosure;

FIG. 7 illustrates the difference in formation modeling between different types of windows selected during window scheming, in accordance with embodiments of the present disclosure; and

FIG. 8 illustrates an exemplary comparison between the first and second inversion image generated by the data processing system, in accordance with embodiments of the present disclosure.

### DETAILED DESCRIPTION

Certain embodiments commensurate in scope with the present disclosure are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below.

As used herein, the term “coupled” or “coupled to” may indicate establishing either a direct or indirect connection (e.g., where the connection may not include or include intermediate or intervening components between those coupled), and is not limited to either unless expressly referenced as such. The term “set” may refer to one or more items. Wherever possible, like or identical reference numerals are used in the figures to identify common or the same elements. The figures are not necessarily to scale and certain features and certain views of the figures may be shown exaggerated in scale for purposes of clarification.

As used herein, the terms “inner” and “outer”; “up” and “down”; “upper” and “lower”; “upward” and “downward”; “above” and “below”; “inward” and “outward”; and other like terms as used herein refer to relative positions to one another and are not intended to denote a particular direction or spatial orientation. The terms “couple,” “coupled,” “connect,” “connection,” “connected,” “in connection with,” and “connecting” refer to “in direct connection with” or “in connection with via one or more intermediate elements or members.”

Furthermore, when introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment,” “an embodiment,” or “some embodiments” of the present disclosure are not intended to be interpreted as excluding the existence of additional embodiments that also incorporate the recited features. Furthermore, the phrase A “based on” B is intended to mean that A is at least partially based on B. Moreover, unless expressly stated otherwise, the term “or” is intended to be inclusive (e.g., logical OR) and not exclusive (e.g., logical XOR). In other words, the phrase A “or” B is intended to mean A, B, or both A and B.

Downhole tools, for example, electromagnetic (EM) logging tools have grown more sophisticated. For example, EM logging tools are capable of providing advanced downhole measurements, which produces a large number of measurement logs. These measurements can be used in real-time or in near real-time to allow for geosteering to occur. For example, measurements (e.g., resistivity measurements) can be made while drilling a wellbore and these measurements can be compared with expected measurement data to generate a formation model. This formation model and, more particularly, the borehole location therein can be utilized to control the direction of drilling.

In this manner, the geosteering process is an interactive approach that combines technology and domain knowledge to deliver optimally placed wellbores as well as to maximize well construction performance through adjustments to a well trajectory in real-time (or in near real-time). As described above, the geosteering process utilizes geological information and measurements taken while drilling to stay within a certain geological target. This technique is often used in horizontal drilling, for example, to maximize the performance of a well by ensuring it remains in the most productive layer of rock. Additionally, the process can be utilized in conjunction with vertical wells, for example, when there is a desire to stop drilling based on a specific geological layer rather than a pre-defined depth.

One technique for the processing of the measurement data taken in conjunction with a geosteering process or operation involves implementing an inversion operation on the measured drilling data, for example, to determine a position of a wellbore with respect to layer boundaries in earth formations. Inversions (inversion operations), thus, can be utilized in geosteering to interpret formation data in real-time while drilling. This allows users and/or control systems to adjust the drilling trajectory to optimize production, reduce risks, etc. In practice, EM logging tools take measurements that are applied to an inversion process that operates to generate a mapping of a reservoir. This mapping, as noted above, can be used in the geosteering process to make informed decisions about the geological formations. Inversion methods (e.g., utilizing a Gauss-Newton method or the like) can be applied to measured data for evaluating subsurface formation resistivity. While these inversion methods can be highly accurate, the inversion methods may cause delays in the information available for control of the drilling system due to the different spacings between transmitter-receiver pairs.

The embodiments discussed in detail below enable processing of drilling data (e.g., sensor measurements) acquired while drilling a borehole from a plurality of transmitter-receiver pairs in first and second stages, wherein the first stage provides a first inversion image in real-time and the second stage provides a second inversion image with a time delay relative to the first inversion image. In particular, the first stage provides a first data analysis (e.g., first inversion image) in real-time closest to the drill bit using a first portion of drilling data from each of the plurality of transmitter receiver pairs (e.g., a rear-facing window). In certain embodiments, the first portion of drilling data may be the earliest portions of drilling data and may only partially overlap or exclude any overlap in measurement range (e.g., depth range) of drilling data between the plurality of transmitter-receiver pairs. As discussed in detail below, the plurality of transmitter-receiver pairs have different measurement spacings between the transmitter and receiver in each of the plurality of transmitter-receiver pairs, and thus the drilling data at any particular time (e.g., real-time) is acquired at different axial positions (e.g., depths) along the borehole for each of the plurality of transmitter-receiver pairs. As a result, the first portion of drilling data from a first transmitter-receiver pair may be at a first measurement range (e.g., axial distance range, depth range), the first portion of drilling data from a second transmitter-receiver pair may be at a second measurement range (e.g., axial distance range, depth range), the first portion of drilling data from a third transmitter-receiver pair may be at a third measurement range (e.g., axial distance range, depth range), and so forth. As a result of the lack of complete measurement overlap in the drilling data used in the first data analysis, the inversion quality of the drilling data from the plurality of transmitter-receiver pairs may be less than a corresponding inversion quality of drilling data having a more complete axial overlap in the drilling data. Nevertheless, the first stage provides the first inversion image in real-time close to the drill bit, thereby enabling real-time control of the drilling system close to the drill bit. In contrast, the second stage provides a second data analysis (e.g., second inversion image) at a later time (e.g., time delay) further away from the drill bit using overlapping portions (e.g., overlapping in positions or range of positions) of drilling data from each of the plurality of transmitter receiver pairs (e.g., a center window). In other words, overlapping portions may be described as overlapping lengths of the borehole being measured by the plurality of transmitter-receiver pairs, such as a common range of 1, 2, 3, 4, 5, 6, 7, 8, 9, 10, or more meters along the borehole. As a result of the overlapping portions of drilling data, the second data analysis provides the second inversion image with increased quality or accuracy relative to the first inversion image, although with the time delay. Thus, the first inversion image may be used by the drilling system to control the drilling parameters (e.g., direction of drilling, the rotational speed of the drill bit, the flowrate of drilling mud, and so forth) in real-time based on real-time drilling data close to the drill bit, whereas the second inversion image may be used by the drilling system to control the drilling parameters with more accuracy (e.g., fine tuning and/or corrections) albeit at a time delay. Various aspects of the disclosed embodiments are discussed in further detail below with reference to the drawings.

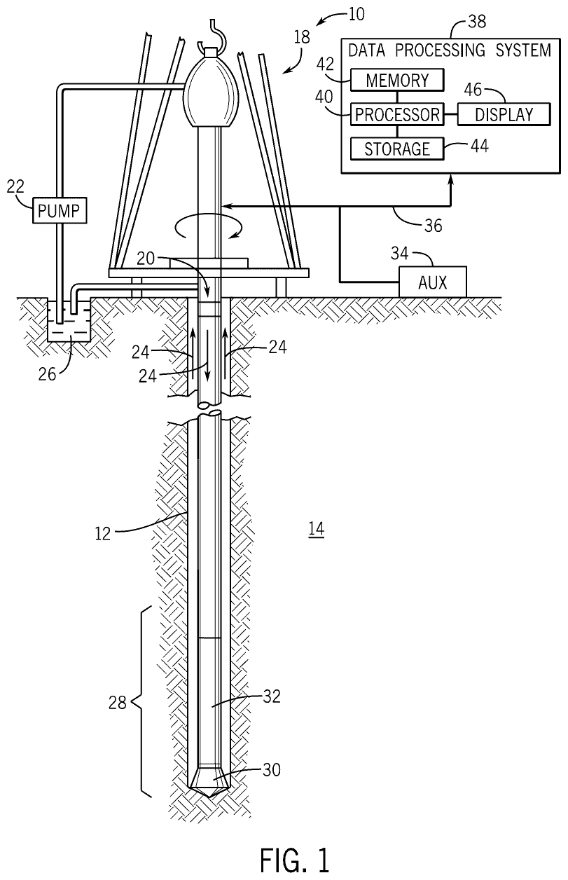

FIG. 1 illustrates a drilling system 10 that may employ the systems and methods of this disclosure. The drilling system 10 may be used to drill a borehole 12 into a geological region 14. In the drilling system 10, a drilling rig 18 may rotate a drill string 20 within the borehole 12. As the drill string 20 is rotated, a drilling fluid pump 22 may be used to pump drilling fluid, which may be referred to as “mud” or “drilling mud,” downward through the center of the drill string 20, and back up around the drill string 20, as shown by reference arrows 24. At the surface, return drilling fluid may be filtered and conveyed back to a mud pit 26 for reuse. The drilling fluid may travel down to the bottom of the drill string 20 known as the bottom-hole assembly (BHA) 28. The drilling fluid may be used to rotate, cool, and/or lubricate a drill bit 30 that may be a part of the BHA 28. The fluid may exit the drill string 20 through the drill bit 30 and carry drill cuttings away from the bottom of the borehole 12 back to the surface. The BHA 28 also includes a rotary steerable system (RSS) configured to enable directional drilling of the drill bit 30, such as by changing a direction of the drill bit 30 to enable geosteering towards desired geological formations.

The BHA 28 may include the drill bit 30 along with various downhole tools, such as one or more logging tools 32. The BHA 28 may thus convey the one or more logging tools 32 through the geological region 14 via the borehole 12. As described in greater detail herein, the one or more logging tools 32 may be any suitable downhole tool that emits electromagnetic waves within the borehole 12 (e.g., a downhole environment). The downhole tools, which may include the one or more logging tools 32, may collect a variety of information relating to the geological region 14 and the state of drilling in the borehole 12. For instance, the downhole tools may be logging-while drilling (LWD) tools that measure physical properties of the geological region 14, such as density, porosity, resistivity, lithology, and so forth. Likewise, the downhole tools may be measurement-while-drilling (MWD) tools that measure certain drilling parameters, such as the temperature, pressure, orientation of the drill bit 30, mapping-while-drilling tools, and so forth.

The one or more logging tools 32 may receive energy from an electrical energy device or an electrical energy storage device, such as an auxiliary power source 34 or another electrical energy source to power the tool. In some embodiments, the one or more logging tools 32 may include a power source within the one or more logging tools 32, such as a battery system or a capacitor, to store sufficient electrical energy to emit and/or receive electromagnetic waves.

Communications 36, such as control signals, may be transmitted from a data processing system 38 (processing system 38) to the one or more logging tools 32, and communications 36, such as data signals related to the results/measurements of the one or more logging tools 32, may be returned to the data processing system 38 from the one or more logging tools 32. The data processing system 38 may be any electronic data processing system that can be used to carry out the systems and methods of this disclosure. For example, the data processing system 38 may include one or more processors 40, which may execute instructions stored in memory 42 and/or storage 44. The memory 42 and/or the storage 44 of the data processing system 38 may be any suitable article of manufacture that can store the instructions. In certain embodiments, the one or more processors 40 may include a microprocessor, a microcontroller, a processor module or subsystem, a programmable integrated circuit, a programmable gate array, a digital signal processor (DSP), or another control or computing device. In certain embodiments, the one or more processors 40 may include machine learning (ML) and/or artificial intelligence (AI) based processors. In present embodiments, the one or more processors 40 may be used to implement machine learning and may include one or more suitable neural network types. For instance, the ML and AI based processors may execute a perceptron, a feed-forward neural network, a multi-layer perceptron, a convolutional neural network, a long short-term memory (LSTM) network, a sequence-to-sequence model, and/or a modular neural network. In some embodiments, the ML and AI based processors may execute at least one deep learning neural network.

In certain embodiments, the memory 42 and storage 44 is implemented as one or more non-transitory computer-readable or machine-readable storage media. In certain embodiments, the memory 42 may include one or more different forms of memory, including semiconductor memory devices such as dynamic or static random access memories (DRAMs or SRAMs), erasable and programmable read-only memories (EPROMs), electrically erasable and programmable read-only memories (EEPROMs) and flash memories. The storage 44 may include solid state drives, magnetic disks such as fixed, floppy and removable disks; other magnetic media including tape; optical media such as compact disks (CDs) or digital video disks (DVDs); or other types of storage devices. Note that the computer-executable instructions and associated data of the analysis module(s) may be provided on one computer-readable or machine-readable storage medium of the memory 42 or the storage 44, or alternatively, may be provided on multiple computer-readable or machine-readable storage media distributed in a large system having possibly plural nodes. Such computer-readable or machine-readable storage medium or media are considered to be part of an article (or article of manufacture), which may refer to any manufactured single component or multiple components. In certain embodiments, the storage 44 may be located either in the machine running the machine-readable instructions or may be located at a remote site from which machine-readable instructions may be downloaded over a network for execution.

As illustrated, the data processing system 38 may optionally also include an electronic display 46, which may be any suitable electronic monitor or display screen, may display images generated by the processor 40. The images displayed on the electronic display may include the drilling data and inversion images discussed in detail below, and also various control options for controlling the drilling system 10 based on the drilling data and inversion images. The data processing system 38 may be a local component of the drilling system 10 (i.e., at the surface), within the one or more logging tools 32 (i.e., downhole), a device located proximate to the drilling operation, and/or a remote data processing device located away from the drilling system 10 to process downhole measurements in real time or sometime after the data has been collected. In some embodiments, the data processing system 38 may be a portable computing device (e.g., tablet, smart phone, or laptop) or a server remote from the drilling system 10. The data processing system 38 also may be described as a controller (e.g., a processor-based controller) and/or a computing device. In some embodiments, the one or more logging tools 32 may store and process collected data in the BHA 28 or send the data to the surface for processing via communications 36 described above, including any suitable telemetry (e.g., electrical signals pulsed through the geological region 14 or mud pulse telemetry using the drilling fluid).

It should be noted that, although the discussion above relates to a drilling system 10, other downhole equipment or systems may employ the systems and methods of this disclosure. For example, a downhole tool with an acoustic tool conveyed by slickline, coiled tubing, wireline, or other delivery systems, may utilize the disclosed systems and methods.

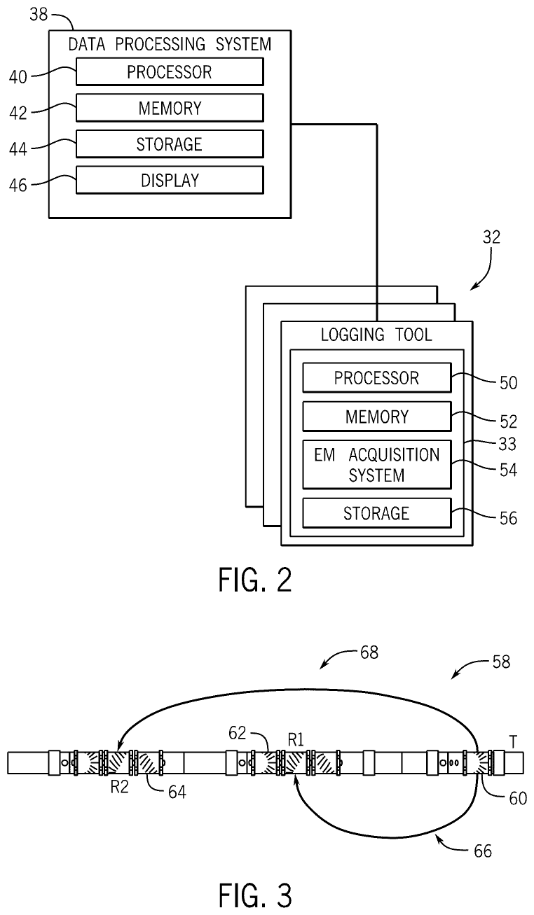

Operation of drilling system 10 may be controlled by a processor of the data processing system 38. For example, FIG. 2 illustrates a block diagram of the data processing system 38 that is communicatively coupled to the one or more logging tools 32. In the illustrated embodiment, a logging tool 32 includes a controller 33 (e.g., a processor-based controller) having a processor 50, memory 52, an electromagnetic (EM) acquisition system 54, and storage 56. In some embodiments, the processor 50 may be ASIC (application specific integrated circuit), field programmable gate array (FPGA), a micro control unit (MCU), a digital signal processor (DSP), and the like. In general, the drilling system 10 communicates with the data processing system 38 via a data cable, wireless communication, or other suitable techniques. For example, the drilling system 10 may communicate EM measurements obtained by an EM sensor (or meter) as part of the EM acquisition system 54. In turn, a processor of the surface control system may determine certain parameters (e.g., porosity, water saturation, permeability, velocities, resistivity, and so forth) based on the EM measurements. In such embodiments, the EM acquisition system 54 may include an emission source (e.g., an antenna) to acquire, obtain, or otherwise measure EM measurements.

In certain embodiments, the data processing system 38 may include one or more analysis modules (e.g., a program of computer-executable instructions and associated data) that may be configured to perform various functions of the embodiments described herein. In certain embodiments, to perform these various functions, the one or more analysis modules may be executed on one or more processors 40 of the processing system 38, which may be connected to memory 42 and storage 44 that store the one or more analysis modules.

In certain embodiments, the computer-executable instructions of the one or more analysis modules, when executed by the one or more processors 40, may cause the one or more processors 40 to generate one or more models (e.g., forward model, inverse model, mechanical model, and so forth). Such models may be used by the processing system 38 to predict values of operational parameters that may or may not be measured (e.g., using gauges, sensors, and so forth) during well operations.

FIG. 3 illustrates an example of an electromagnetic (EM) logging tool 58 that can be utilized as one of the one or more logging tools 32. The EM logging tool 58 (e.g., EM tool 58), as illustrated, includes one or more coils (e.g., co-axial coils) as a transmitter 60 as well as receiver 62 and receiver 64 disposed along the EM tool 58. The transmitter 60 may be disposed in the borehole 12 a proximate distance to the drill bit 30, such as within 1, 2, or 3 meters from the drill bit 30. That is, the transmitter 60 may consistently maintain the proximate distance to the drill bit 30. One or both of the receiver 62 and the receiver 64 can include tilted and/or transverse and/or axial coils (e.g., antenna). This results in mapping-while-drilling or LWD services that provide rapid and high delineation of reservoir layers and formation evaluation while drilling.

The transmitter 60 may communicate directly with each receiver 62, 64 and form a first transmitter-receiver pair 66 and a second transmitter-receiver pair 68 of a plurality of transmitter-receiver pairs. In some embodiments, the first transmitter-receiver pair 66 is the closest transmitter-receiver pair relative to the drill bit 30. It should be noted that the EM logging tool 58 may include additional receivers that are not illustrated in FIG. 3 that form additional transmitter-receiver pairs of the plurality of transmitter-receiver pairs. The transmitter 60 is disposed between the receivers 62, 64 and the drill bit 30, where the downhole drilling direction is towards the right.

The EM tool 58 is configured to acquire drilling data (e.g., sensor measurements) from each of a plurality of transmitter-receiver pairs (e.g., 66 and 68), store the drilling data, transmit the drilling data to one or more computing devices, analyze the drilling data, and perform an inversion process on the drilling data in real-time and/or at various thresholds (e.g., time intervals, depth intervals, etc.) during the drilling operation. For example, the EM tool 58 can be configured to transmit collected measurements that coincide with a particular stage of mapping-while-drilling or LWD operations as the measurements are taken in real-time by the EM tool 58. Additionally, in some embodiments, the EM tool 58 may be configured to collect and transmit a portion of drilling data to the one or more processors 40 of the data processing system 38 in real-time and/or at a particular time, depth, or both. For example, the EM tool 58 may acquire and transmit drilling data from a first portion (e.g., earliest portion of measurements, earliest data point, and/or earliest time interval in real-time) for each of the plurality of transmitter-receiver pairs (e.g., 66 and 68). The first portions of the drilling data from the plurality of transmitter-receiver pairs can be used for a first analysis (e.g., first inversion image) closest in position and time to the BHA 28 and the drill bit 30, and thus the data processing system 38 may be configured to provide real-time control of the drilling system 10 (e.g., direction of drilling, rotational speed of drill bit 30, flowrate of drilling mud, etc.). Subsequently, after some time delay and distance of travel of the drill bit 30, overlapping portions of the drilling data from the plurality of transmitter-receiver pairs can be used for a second analysis (e.g., second inversion image) that is more accurate than the first inversion image. The foregoing inversion images can be generated in conjunction with 1D, 2D, and 3D inversion workflows and various inversion algorithms, such as DPI, PIX, MC3, etc.

Using the foregoing inversion workflows, the data processing system 38 may communicate with the one or more logging tools 32 to map formation resistivity of the surroundings of the borehole 12 using both the first inversion image (e.g., real-time) and the second inversion image (e.g., time delayed but more accurate). Formation resistivity is an indicator of how a geological formation resists the flow of electric current and may indicate the presence of fluids. As such, the data processing system 38 may map the formation resistivity by applying an inversion algorithm to the drilling data measured by the plurality of transmitter-receiver pairs by the one or more logging tools 32. The data processing system 38 may display the inverted data as viewable and interactable inversion image on the electronic display 46. Additionally, the data processing system 38 may display control options on the electronic display 46 and/or initiate automatic control of the drilling system 10 in real-time or near real-time, such as adjusting directional drilling via the RSS at the BHA 28.

As discussed in further detail below, the data processing system 38 may process the first portion of drilling data from each of the plurality of transmitter-receiver pairs in the borehole 12 to produce the first inversion image (e.g., an early image and/or real-time image of a first image quality) and later process overlapping drilling data from each of the plurality of transmitter-receiver pairs in the borehole 12 to produce a second inversion image (e.g., time delayed image of a second image quality). In general, the first image quality is lower than the second image quality; however, the first inversion image is available in real-time or near real-time to make real-time adjustments to the drilling system 10. In contrast, the second image quality is higher than the first image quality; however, the second inversion image is delayed by a time delay and distance away from the drill bit 30. Thus, as discussed in further delay below, the first inversion image can be used for a first control (e.g., rough or approximate control) of the drilling system 10, whereas the second image can be used for a second control (e.g., fine tuning and/or correctional control) of the drilling system 10. In this manner, the first inversion image enables the data processing system 38 to make proactive drilling decisions based on mapped formation resistivity data at a most recent time or depth interval of the borehole 12. Various aspects of the inversion workflow to provide first and second inversion images is discussed in further detail below.

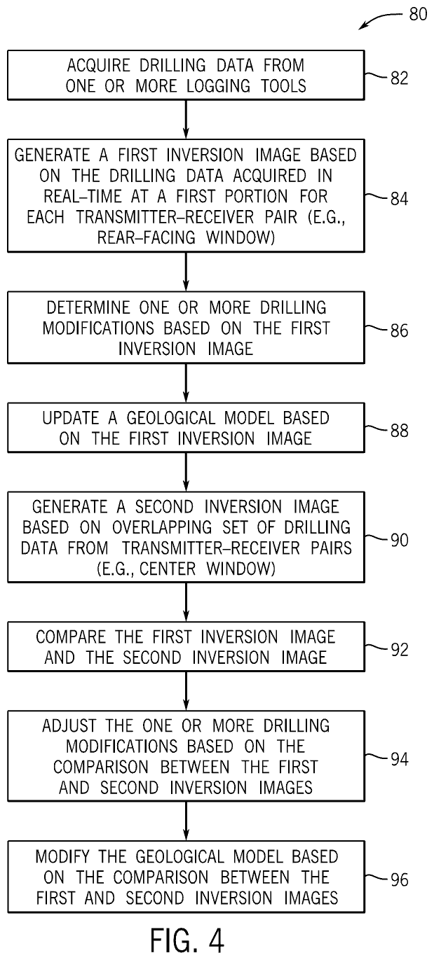

FIG. 4 illustrates a method 80 for mapping the formation resistivity found between each transmitter-receiver pair of the plurality of transmitter-receiver pairs to determine one or more drilling decisions. It should be noted that one or more of the blocks of the method 80 may be performed by the data processing system 38 (e.g., via the one or more processors 40 executing code stored in the one or more of the memory 42 or the storage 44). Additionally, one or more of the blocks of the method 80 can be performed by the processor 50 in conjunction with the memory 52 or storage 56 of the controller 33 of the logging tool 32. Furthermore, the blocks of the method 80 need not be performed in the illustrated order and one or more of the blocks may be selectively omitted.

At block 82, the data processing system 38 may acquire drilling data (e.g., sensor measurements) from the one or more logging tools 32 of the drilling system 10. The one or more logging tools 32 may collect a variety of information relating to the geological region 14 and the state of drilling in the borehole 12. This drilling data may include formation characteristics and/or parameters to be solved in conjunction with the LWD or mapping-while-drilling operation. The input values can also include, for example, well trajectory information (i.e., depths, angles, and/or other characteristics of the well being drilled). The input values can also include, for example, a tool channel list that represents all the channels for measurement logs that can be transmitted by the EM tool 58. The data processing system 38 may acquire the drilling data in real-time with minimum latency from the one or more logging tools 32.

The data processing system 38 may receive drilling data collected from one or more transmitter-receiver pairs of the plurality of transmitter-receiver pairs to produce the inversion image showing the mapping of the formation resistivity. By way of example, the data processing system 38 may receive the drilling data (e.g., sensor measurements) from the first transmitter-receiver pair 66, the second transmitter-receiver pair 66, a third transmitter-receiver pair, and/or any number of additional transmitter-receiver pairs. Each of the transmitter-receiver pairs may have a different axial spacing relative to a central axis of the EM tool 58. For example, the transmitter-receiver pairs may share a common transmitter, wherein each of the transmitter-receiver pairs has a respective receiver spaced progressively further away from the common transmitter.

As a result, in real-time, the drilling data (e.g., sensor measurements) from each of the transmitter-receiver pairs may be at different axial positions along the EM tool 58, and thus correspond to different depths along the borehole 12. For example, the first transmitter-receiver pair 66 may obtain measurements in real-time at a first axial position (e.g., a first depth in the borehole 12) close to the drill bit 30, the second transmitter-receiver pair 68 may obtain measurements in real-time at a second axial position (e.g., second depth in the borehole 12) further away from the drill bit 30 and the first axial position, the third transmitter-receiver pair may obtain measurements in real-time at a third axial position (e.g., third depth in the borehole 12) further away from the drill bit 30 and the second axial position, and so forth. In other words, the real-time measurements from the various transmitter-receiver pairs are not simultaneously available at the first axial position, which is the deepest depth in the borehole 12 closest to the drill bit 30. In order to analyze all measurements at a common axial position, the analysis and inversion process would be delayed for an amount of time until all of the drilling data is available at a common axial position (e.g., depth in the borehole 12), as discussed in further detail below at block 90. For example, the analysis and inversion process would be delayed until the second axial position for an embodiment of the EM tool 58 having the first and second transmitter-receiver pairs 66 and 68. By further example, the analysis and inversion process would be delayed until the third axial position for an embodiment of the EM tool 58 having the first transmitter-receiver pair 66, the second transmitter-receiver pair 68, and the third transmitter-receiver pair. However, in the illustrated embodiment, the method 80 performs the analysis and inversion process earlier to obtain real-time drilling data closer to the drill bit, as discussed in further detail below at block 84.

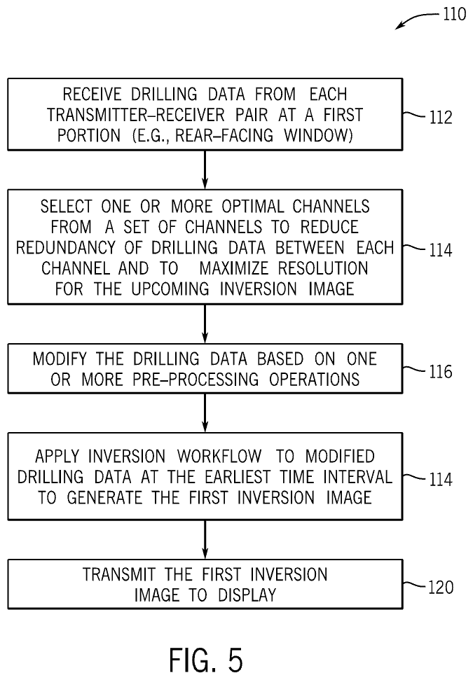

At block 84, the data processing system 38 may generate a first inversion image based on a first set of measurement data (e.g., drilling data, sensor measurements) acquired in real-time at the first portion (e.g., earliest portion of measurements, an earliest time interval, and/or measurements starting directly at a real-time measurement) for each transmitter-receiver pair. That is, the data processing system 38 may select to immediately process the most available and up-to-date real-time drilling data from each transmitter-receiver pair without waiting for the drilling data for each transmitter-receiver pair to be available at the common axial position (e.g., common depth in the borehole 12). For example, the data processing system 38 may process the drilling data from each transmitter-receiver pair using a rear-facing window, which extends rearwardly from a first point (i.e., a real-time data point) to a second point (i.e., offset rearwardly from the real-time data point) for each of the transmitter-receiver pairs. The rear-facing window may be defined as a rear-facing time window starting at the current time as the first point to a time in the past as the second point, wherein the rear-facing time window may be an earliest time interval of drilling data for each of the transmitter-receiver pairs. In certain embodiments, the rear-facing time window may be the earliest 1-5 minutes of drilling data for each of the transmitter-receiver pairs. The rear-facing window may be defined as a rear-facing measurement range window (e.g., a rear-facing depth window) starting at the current axial distance or position (e.g., depth) as the first point to an axial position or depth further behind the drill bit 30. In certain embodiments, the rear-facing axial distance window (e.g., rear-facing depth window) may be the earliest or closest 1 to 15 meters, 1 to 10 meters, 1 to 5 meters, or the like, relative to the drill bit 30 of drilling data for each of the transmitter-receiver pairs. In some embodiments, the earliest portion of drilling data for each of the transmitter-receiver pairs using the rear-facing window only partially overlaps in axial distance (e.g., depth in the borehole 12), such as an overlap of about 1 to 50, 1 to 25, or 1 to 10 percent of the rear-facing window for each of the transmitter-receiver pairs. However, the earliest portion of drilling data for each of the transmitter-receiver pairs using the rear-facing window does not overlap in axial distance (e.g., depth in the borehole 12). In either case, despite the less than complete overlap, the first inversion image provides valuable real-time information about the geological formation close to the drill bit 30, thereby enabling control of the drilling system 10 in real-time closest to the current position of the drill bit 30. In certain embodiments, the data processing system 38 applies an inversion workflow to the first portion of drilling data from the transmitter-receiver pairs to generate the first inversion image, which provides a quick-view (e.g., real-time view close to the drill bit 30) ahead of a detailed view (e.g., precision view based on overlapping data) provided by the method 80 in block 90. Each of the quick-view and the detailed view may be displayed on an electronic display 46 and used for real-time control of the drilling system 10. This is discussed further below in FIG. 5.

At block 86, the data processing system 38 may determine one or more drilling modifications based on the first inversion image (e.g., displayed via the electronic display 46). As discussed above, inversion images can provide insight into the formation resistivity of the surrounding material. That is, the data processing system 38 may analyze patterns, conditions, and additional metrics of the mapped formation resistivity to determine the one or more drilling modifications to the drilling system 10. The one or more drilling modifications may include a drilling path, a direction of drilling via the RSS at the BHA 28, a rotational speed of the drill bit, a flow rate of drilling mud, a weight on bit (WOB), an intensity, or any other relevant changes that impact the drilling of the borehole 12. The data processing system 38 may transmit one or more commands to the drilling system 10 based on the one or more drilling modifications. In some embodiments, the data processing system 38 may delay transmission of the one or more commands until an additional inversion image is generated by the data processing system 38.

At block 88, the data processing system 38 may update a geological model based on the first inversion image. The one or more processors 40 of the data processing system 38 may include machine learning (ML) and/or artificial intelligence (AI) based processors to execute a geological model. That is, the one or more processors 40 may train the geological model based on previous drilling data and previously generated inversion images. The one or more processors 40 may feed the drilling data into the geological model to generate a geological model prediction. That is, the data processing system 38 may generate the geological model prediction to represent a prediction of the formation resistivity of the surrounding materials without processing the drilling data through the inversion workflow.

Upon generating the first inversion image, the data processing system 38 may compare the first inversion image to the geological model prediction and update the geological model prediction based on a similarity value. The similarity value is a measure of similarity between the predicted formation resistivity of the geological model prediction and an actual formation resistivity from the first inversion image. The data processing system 38 may automatically and in real-time compare the similarity value to a similarity threshold when comparing each formation resistivity. Upon determining the similarity value is below the similarity threshold, the data processing system 38 may update the geological model such that the geological model discards the geological model prediction and generates an updated geological model prediction. Upon determining the similarity value is above the similarity threshold, the data processing system 38 may update the geological model such that the geological model prediction is retained and reinforced in the training of the geological model.

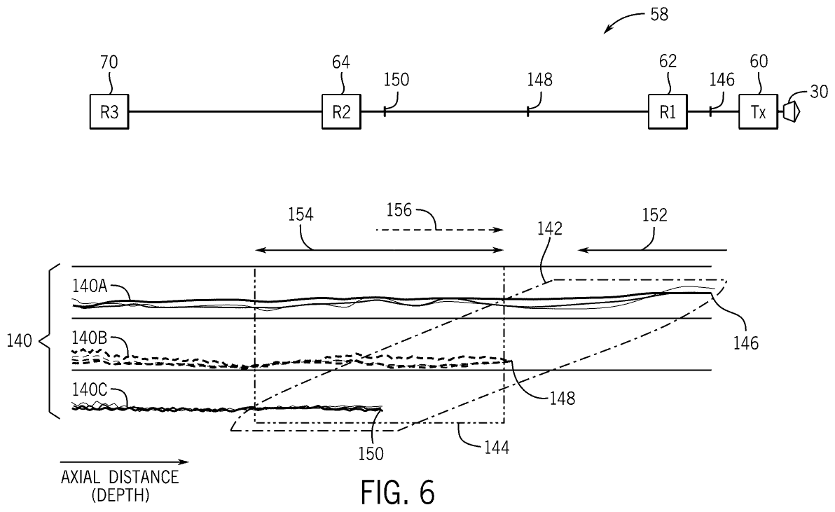

At block 90, the data processing system 38 may generate a second inversion image based on the overlapping set of drilling data from each of the plurality of transmitter-receiver pairs. That is, the data processing system 38 may generate a higher quality inversion image (i.e., the second inversion image) upon receiving all of the drilling data of each transmitter-receiver pair at a selected common axial position (or a center window covering an overlapping distance of measurements). The overlapping distance of measurements may include, for example, an overlapping depth in a borehole being drilled by the drill bit 30. In certain embodiments, the overlapping distance or depth may be a distance of 1 to 15 meters, 1 to 10 meters, 1 to 5 meters that is the same for each of the plurality of transmitter-receiver pairs. As discussed above, the data processing system 38 may generate the first inversion image by using any available drilling data at an early time interval (e.g., first portion of measurements, earliest time interval, and/or measurements starting directly at or near real-time measurement data points) from each transmitter-receiver pair, where each of the transmitter-receiver pairs may be located at different axial positions. By shifting the rear-facing window of block 84 to a center-window in block 90, the data processing system 38 may generate a higher quality and more detailed inversion image (i.e., the second inversion image) as compared to the first inversion image by analyzing all of the drilling data at a selected common axial position (e.g., overlapping distance of measurements). In other words, each of the transmitter-receiver pairs will provide measurements over the same axial distance along the EM tool 58 (or depth range of the borehole), such that greater accuracy is possible for the second inversion image. That is, the center window is centered at the common axial position and extends in opposite axial directions to define the overall distance of measurements. As discussed below with reference to FIG. 6, the center window forms a rectangle that defines the bounds of the drilling data centered at the selected common axial position. The center window and its bounds cover the drilling data from each transmitter-receiver pair at the selected common axial position. Since different transmitter-receiver pairs have different relative distances (e.g., between each receiver 62, 64, 70, and the transmitter 60), the data processing system 38 delays analysis until all the drilling data encompassed within the center window is received, and thus a time delay exists for the inversion workflow to generate the second inversion image.

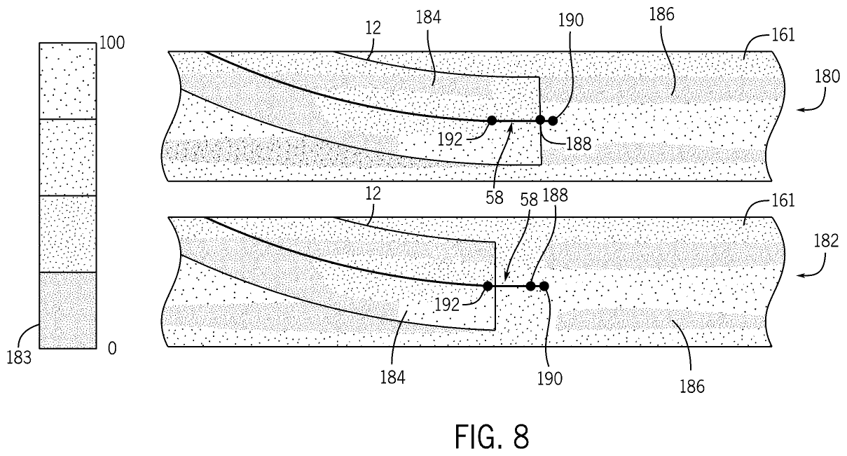

At block 92, the data processing system 38 may compare the first inversion image and second inversion image. The data processing system 38 may automatically compare the first and second inversion image to determine if the first inversion image is accurately representative of the geological formations at a particular common axial position. As discussed above, the first inversion image provides a quick-view into the geological formations around the drill bit 30 and is potentially indicative of the geological formations behind the drill bit 30 and a different axial positions. As discussed above, the first inversion image is representative of an initial look into the geological formation at and around the drill bit 30 in real-time during drilling. By comparing the first inversion image with the second inversion image, the data processing system 38 may determine if projections made based on the first inversion image are still applicable and/or changes to the one or more drilling modifications are suggested/necessary. This may be performed automatically by the data processing system 38 upon generating the second inversion image. The data processing system 38 may perform various image analysis techniques using optical recognition imaging software and/or machine learning to assign confidence scores to the first and second inversion image. The data processing system 38 may determine a resolution ratio and/or an accuracy ratio that are representative of differences between the resolutions and/or accuracy of the first inversion image relative to the second inversion image. Due to the second inversion image being a higher definition and more expansive image compared the first inversion image, the data processing system 38 may determine that the differences (e.g., resolution and/or accuracy ratio) between the first and second inversion images indicate modifications to the one or more drilling modifications is necessary/suggested. This comparison will be discussed further in FIG. 8.

At block 94, the data processing system 38 may adjust the one or more drilling modifications (e.g., rotational speed, direction of drilling, flow rate of drilling mud, weight on bit, etc.) determined at block 86 based on the comparison between the first inversion image and the second inversion image. The data processing system 38 may automatically adjust the one or more drilling modifications based on the automatic comparison at block 92. The data processing system 38 may determine that no modifications are needed based on the comparison. In other embodiments, the data processing system 38 may modify the one or more drilling modifications based on the second inversion image alone, without comparing the first inversion image and the second inversion image. At block 96, the data processing system 38 may modify the geological model based on the comparison between the first inversion image and the second inversion image. In other embodiments, the data processing system 38 may modify the geological model based on the second inversion image without the first inversion image.

FIG. 5 illustrates a method 110 for computing the first inversion image as illustrated in FIG. 4. It should be noted that one or more of the blocks of the method 110 may be performed by the processing system 38 (e.g., via the one or more processors 40 executing code stored in the one or more of the memory 42 or the storage 44). Additionally, one or more of the blocks of the method 110 can be performed by the processor 50 in conjunction with the memory 52 or storage 56 of the controller 33 of the logging tool 32. Furthermore, the blocks of the method 110 need not be performed in the illustrated order and one or more of the blocks may be selectively omitted.

At block 112, the data processing system 38 may receive drilling data from each transmitter-receiver pair at a first portion (e.g., earliest time interval) via the one or more logging tools 32. For example, the data processing system 38 may receive the first portion (e.g., earliest time interval) of the drilling data from each transmitter-receiver pair of the logging tool 32 in real-time or at least near real-time, wherein the earliest time interval may correspond to a rear-facing window as discussed in further detail below with reference to FIG. 6. The data processing system 38 may associate the drilling data with particular transmitter-receiver pairs, such as associating a first set of the drilling data with the first transmitter-receiver pair 66 and/or a second set of the drilling data with the second transmitter-receive pair 68. The data processing system 38 may receive a preliminary set of the drilling data from each transmitter-receiver pair at the earliest time interval prior to receiving the overlapping set of drilling data from each transmitter-receiver pair as discussed above with reference to block 90 of FIG. 4.

At block 114, the data processing system 38 may select one or more optimal channels from a set of channels to reduce redundancy of drilling data between each channel and to maximize resolution for the upcoming inversion image. That is, multiple channels of the set of channels may provide overlapping data that is not necessary to compute an accurate result, and as such the data processing system 38 may select the one or more optimal channels which may reduce overall processing time and redundant processing.

At block 116, the data processing system 38 may modify the drilling data based on one or more pre-processing operations. For example, the one or more pre-processing operations may include window scheming, weighting, and missing data processing. The window scheming includes segmentation of the drilling data into different intervals or windows (e.g., rear-facing window and center window) for inversion workflows to generate different inversion images (e.g., first and second inversion images) as discussed in further detail below in FIG. 6. In the method 110 of FIG. 5, the window scheming focuses on the rear-facing window. The weighting refers to controlling the importance of different data points to lead to better fitting models and allows prior models to impact current calculations. Finally, the data processing system 38 may handle missing data in the drilling data via interpolation, sparse inversion, and/or soft-constraint handling.

At block 118, the data processing system 38 may apply the inversion workflow to the modified drilling data at the first portion (e.g., early or earliest time interval and/or measurements starting directly at or near real-time measurement data points) to generate the first inversion image. That is, the data processing system 38 may apply the inversion workflow to the modified drilling data to estimate physical properties of the subsurface surrounding and/or within the borehole 102. In some embodiments, the data processing system 38 may use linear or nonlinear inversion, stochastic or deterministic methods, or machine learning techniques to improve accuracy and computational efficiency of the inversion workflow. For example, the data processing system 38 may integrate the drilling data with well log data, prior geological knowledge, or constraints such as rock physics models to refine and generate the first inversion image.

It should be understood that there are respective inversion workflows for each dimensional parameter. That is, the data processing system 38 may select between one-dimensional (“1D”), two-dimensional (“2D”), and three-dimensional (“3D”) inversion workflows to produce a 1D inversion image, a 2D inversion image, and a 3D inversion image, respectively. This is particularly useful for providing initial guesses for the next dimensional image. That is, the 1D inversion image may be useful as an initial estimate for a high-quality 1D inversion image or 2D inversion images. The 2D inversion image may be useful as an initial estimate for the 3D inversion image. Additionally, the data processing system 38 may determine that a particular dimensional parameter is a poor-fit to inform drilling decisions and select a different dimensional parameter to perform the inversion workflow.

At block 120, the data processing system 38 may transmit the first inversion image to the electronic display 46. The first inversion image may indicate properties like acoustic impedance, porosity, density, or velocity. As discussed above, the data processing system 38 may determine the one or more drilling operations based on the first inversion image. The data processing system 38 may transmit the first inversion image to an external computing device for processing and/or storage. As discussed above, the data processing system 38 may process the drilling data prior to generating the first inversion image. The data processing system 38 may use window scheming (e.g., rear-facing window) to process the drilling data to generate the first inversion image.

FIG. 6 illustrates an example of window scheming to obtain the first inversion image and the second inversion image as described in FIGS. 4 and 5. The data processing system 38 may receive drilling data 140 to generate the first inversion image and the second inversion image. The drilling data 140 includes data 140A (e.g., sensor measurements) captured between the transmitter 60 (Tx) and the receiver 62 (R1) as the first transmitter-receiver pair 66, data 140B (e.g., sensor measurements) captured between the transmitter 60 (Tx) and the receiver 64 (R2) as the second transmitter-receiver pair 68, and data 140C (e.g., sensor measurements) captured between the transmitter 60 (Tx) and the receiver 70 (R3) as the third transmitter-receiver pair. As discussed above, the data processing system 38 may perform window scheming to produce the inversion images. Window scheming refers to the segmentation of the drilling data into different intervals or windows. For example, the data processing system 38 may process the drilling data using a rear-facing window 142 to generate the first inversion image and a center window 144 to generate the second inversion image.

As discussed above, the data processing system 38 may process the drilling data from each transmitter-receiver pair using the rear-facing window 142, which extends rearwardly from point 146 (i.e., a real-time data point) a set distance 152, such that it is offset rearwardly from the point 146. Similarly, the rear-facing window extends from point 148 (i.e., a real-time data point) a set distance 152, such that it is offset rearwardly from point 148. Additionally, the rear-facing window extends from point 150 (i.e., a real-time data point) a set distance 152, such that it is offset rearwardly from point 150. That is, the data processing system 38 may set the rear-facing window 142 to capture the earliest available data for each transmitter-receiver pair. As illustrated in FIG. 6, the rear-facing window includes a first measurement range 152 (e.g., an axial distance range, depth range) of the drilling data 140A associated with the first transmitter-receiver pair 66, a second measurement range 152 (e.g., an axial distance range, depth range) of the drilling data 140B associated with the second transmitter-receiver pair 68, and a third measurement range 152 (e.g., axial distance range, depth range) of the drilling data 140C associated with the third transmitter-receiver pair. For example, each measurement range 152 or axial distance range may include a range of 1 to 5, 1 to 10, or 1 to 15 meters of drilling data. However, the measurement range 152 or axial distance range of the drilling data 140A, 140B, and 140C within the rear-facing window may not overlap at all in the axial direction (e.g., depth direction), or there may only be a partial axial overlap of less than about 5, 10, 15, 20, 30, 40, or 50 percent. As an example, the first measurement range 152 (e.g., depth range) of the drilling data 140A may include data acquired at depths of 980 to 1000 feet, the second measurement range 152 (e.g., depth range) of the drilling data 140B may include data acquired at depths of 970 to 990 feet, and the third measurement range 152 (e.g., depth range) of the drilling data 140C may include data acquired at depths of 960 to 980 feet. By segmenting based on the rear-facing window 142, the data processing system 38 may focus on the subsurface properties determined from the drilling data associated with the transmitter-receiver pair at the earliest time interval to enable proactive drilling decisions and control of drilling parameters of the drilling system 10 without waiting for all the drilling data to process over a common or overlapping measurement range or range along the EM tool 58.

The center window 144 may correspond to a window centered around a chosen midpoint, shown as point 150 in FIG. 6, to process drilling data 140 received over a common or overlapping measurement range 154 or range (e.g., depth range) from each transmitter-receiver pair. As discussed above, in real-time, each transmitter-receiver pair acquires drilling data at a different axial position along the EM tool 58 and the borehole due to the varying spacings of transmitter-receiver pairs, and thus the processing of the drilling data is delayed until the drilling data 140A, 140B, and 140C sufficiently covers the center window 144 to generate the second inversion image. That is, the first portion of the drilling data for one or more of the transmitter-receiver pairs may be before the center window or before the midpoint (e.g., the inversion point) of the center window. In other words, the center window does not include the first portion of drilling data for all of the transmitter-receiver pairs. For example, in real-time, the data 140A is acquired with the first transmitter-receiver pair 66 at the first point 146 (e.g., first axial position) midway between the transmitter 60 and the receiver 62; however, the first point 146 (and thus the first portion of drilling data) is not within the center window 144. In real-time, the data 140B is acquired with the second transmitter-receiver pair 68 at the second point 148 (e.g., second axial position) midway between the transmitter 60 and the receiver 64. The second point 148 is within the center window 144 in the illustrated embodiment. In real-time, the data 140C is acquired with the third transmitter-receiver pair at the third point 150 (e.g., third axial position) midway between the transmitter 60 and the receiver 70; however, the third point is also midway within the center window 144. As a result, the inversion process using the center window 144 may require a time delay 156 due to the third point 150 of the data 140C being at the midpoint of the center window 144. In certain embodiments, the rear-facing window 144 using the data 140A enables the first inversion image (e.g., a quick-look inversion) for substantially real-time analysis of the geological formation and control of the drilling equipment. For example, in certain embodiments, the first inversion image (e.g., a quick-look inversion) may be a 1D inversion image; however, the first inversion image may include a 2D or 3D inversion image.

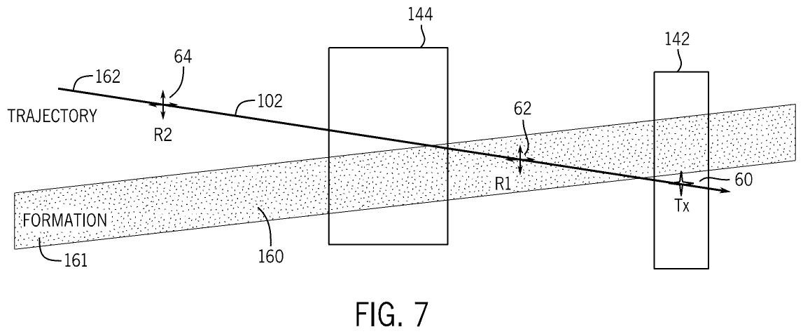

FIG. 7 illustrates the difference in formation modeling when selecting between the rear-facing window 142 and the center window 144. A formation dip 160 is representative of subsurface geological data, including a geological formation 161, and is the target for the drilling via the borehole 102. As seen in FIG. 7, the formation dip 160 and a trajectory inclination 162 of the drill string having the drill bit 30 generating the borehole 102 are shown crossing one another. If not producing the first inversion image via the rear-facing window 142, the data processing system 38 may use the center window 144 to produce the second inversion image and make drilling decisions with a substantial time delay further away from the drill bit 30. Without additional inversion images, the current trajectory of both the formation dip 160 and the trajectory inclination 162 cannot be confirmed in a timely manner, and thus the trajectory inclination 162 may cross over and miss the formation dip 160. By performing the method 110 of FIG. 110 and generating the first inversion image, the data processing system 38 may determine specific drilling decisions that allow for the trajectory inclination 162 to align closer with the formation dip 160 by making preliminary determinations based on the geological formations at an early time interval (e.g., first portion of measurements, earliest time interval, and/or measurements starting directly at or near real-time measurement data points). Thus, by using the first inversion image based on the rear-facing window 144, the data processing system 38 may enable real-time control of operational parameters of the drilling system 10 (e.g., direction of drilling, rotational speed of drill bit 30, flow rate of drilling mud, etc.) to drill into the formation dip 160 rather than crossing over the formation dip 160. Upon generating the second inversion image, the data processing system 38 may generate a higher quality and more complete image of the geological formation 161, allowing for updates to the geological model and/or correction of controls (e.g., control refinements, adjustments, etc.) made to the drilling system 10 based on the first inversion image.

FIG. 8 illustrates an exemplary comparison between the images generated by the data processing system 38, illustrating a graph 180 corresponding to the first inversion image and a graph 182 corresponding to the second inversion image. Each graph 180, 182 illustrates different levels of resistivity within the borehole 12 and the surrounding geological formation 161. For example, the different shading found within each graph 180, 182 may designate different levels of resistivity in the geological formation 161, as denoted by scale 183. Each graph 180, 182 includes a region 184 associated with the borehole 12 and a region 186 of the geological formation 161 surrounding the borehole 12. In the graph 180, the region 184 extends to a position 188 in close proximity to a position 190 of the drill bit 30 based on the rear-facing window 142 used for the first inversion image. In contrast, in the graph 182, the region 184 extends to a position 192 further away from the drill bit 30 based on the center window 144 used for the second inversion image. For example, the position 188 may be based on the position of the transmitter 60 of FIGS. 3 and 6, whereas the position 190 may be based on the mid-point of the data 140 in FIG. 6. By further example, the position 190 may be based on the point 150 in the center window 142 of FIG. 6. As illustrated by a comparison of graphs 180 and 182, the region 184 of the first inversion image of the graph 180 is closer to the drill bit 30 to enable real-time control changes to the drilling system 10, whereas the region 184 of the second inversion image of the graph 182 is further away from the drill bit 30 albeit with higher quality/precision to enable corrections to previous control changes based on the first inversion image.

The technical effect of the disclosed embodiments include a plurality of stages of inversion images associated with drilling data (e.g., sensor measurements) acquired from a plurality of transmitter-receiver pairs while drilling a borehole. The first stage of inversion images uses a rear-facing window to perform an inversion process of a first portion of the drilling data from each of the plurality of transmitter-receiver pairs, thereby providing a first inversion image without a time delay to enable real-time control of the operational parameters of the drilling system. The second stage of inversion images uses a center window to perform an inversion process on overlapping portions (e.g., common or overlapping measurement range or range, depth) of drilling data from each of the plurality of transmitter-receiver pairs, thereby providing a second inversion image with a time delay but with improved accuracy due to the overlapping portions of drilling data. The first inversion image may be of lower quality than the second inversion image; however, the first inversion image enables immediate changes in the drilling system (e.g., direction of drilling, rotational speed of drill bit, flow rate of drilling mud, etc.). The second inversion image is generated later after the first inversion image with improved quality, thereby enabling adjustments to the control of drilling equipment. Thus, the disclosed embodiments enable a combination of fast, reduced quality inversion images and slow, increased quality inversion images to obtain an improved overall performance in control of the drilling system.

The subject matter described in detail above may be defined by one or more clauses, as set forth below.

A method includes receiving a first set of measurement data from a plurality of transmitter-receiver pairs of a measurement tool coupled to a drill string of a drilling system, wherein the first set of measurement data includes a first portion of measurement data from each of the plurality of transmitter-receiver pairs. The method further includes generating a first inversion image based on the first set of measurement data, updating a geological model based on the first inversion image, and controlling one or more operational parameters of the drilling system substantially in real-time based on the geological model.

The method of the preceding clause, including receiving a second set of measurement data from the plurality of transmitter-receiver pairs after receiving the first set of measurement data, wherein the second set of measurement data includes a second portion of measurement data from each of the plurality of transmitter-receiver pairs at an overlapping measurement range. The method further includes generating a second inversion image based on the second set of measurement data, updating the geological model based on the second inversion image, and controlling the one or more operational parameters of the drilling system based on the geological model.

The method of any preceding clause, wherein the second inversion image has a higher quality than the first inversion image.

The method of any preceding clause, wherein the second portion of measurement data from each of the plurality of transmitter-receiver pairs at the overlapping measurement range is within a center window.

The method of any preceding clause, wherein each of the plurality of transmitter-receiver pairs has an axial spacing between a transmitter and a receiver, and the axial spacing varies between the plurality of transmitter-receiver pairs.

The method of any preceding clause, wherein the transmitter is shared by the plurality of transmitter-receiver pairs, and the transmitter is closer to a drill bit of the drill string than each receiver of the plurality of transmitter-receiver pairs.

The method of any preceding clause, wherein the plurality of transmitter-receiver pairs includes a first transmitter-receiver pair, a second transmitter-receiver pair, and a third transmitter-receiver pair.

The method of any preceding clause, wherein the first portion of measurement data from each of the plurality of transmitter-receiver pairs is within a rear-facing window.

The method of any preceding clause, wherein the rear-facing window includes a trapezoidal window.

The method of any preceding clause, wherein the rear-facing window extends rearwardly from a first point to a second point, the second point is offset rearwardly from the first point for each of the plurality of transmitter-receiver pairs, and the first point is representative of a real-time data point at an earliest time interval.

The method of any preceding clause, wherein the first set of measurement data include electromagnetic measurements, and the measurement tool includes an electromagnetic measurement tool.

The method of any preceding clause, wherein updating the geological model based on the first inversion image includes generating a geological model prediction based on the first set of measurement data, comparing the first inversion image to the geological model prediction to obtain a comparison, and determining a similarity value based on the comparison. The method further includes upon determining the similarity value is below a similarity threshold, updating the geological model to discard the geological model prediction, and generate an updated geological model prediction based on the first inversion image. The method further includes upon determining the similarity value is above the similarity threshold, updating the geological model such that the geological model prediction is retained.

The method of any preceding clause, wherein generating the first inversion image includes selecting one or more optimal channels from a set of channels, wherein the one or more optimal channels reduce redundancy of drilling data between each channel of the set of channels. The method further includes modifying the first set of measurement data based on one or more pre-processing operations to obtain modified measurement data. The method further includes selecting an inversion workflow to apply to the modified measurement data, wherein the inversion workflow includes a one-dimensional (“1D”) inversion workflow, a two-dimensional (“2D”) inversion workflow, or a three-dimensional (“3D”) inversion workflow. The method further includes applying the inversion workflow to the modified measurement data to generate the first inversion image.

The method of any preceding clause, including updating the inversion workflow based on the first inversion image, wherein the one or more pre-processing operations include window scheming operations, weighting operations, missing data handler operations, or any combination thereof.

A system includes a computing system having one or more processors, wherein the computing system is communicatively coupled with a drilling system, and a memory storing instructions that, when executed by the computing system, are configured to cause the computing system to perform operations. The operations are configured to receive a first set of measurement data from a plurality of transmitter-receiver pairs of a measurement tool coupled to a drill string of a drilling system, wherein the first set of measurement data includes a first portion of measurement data from each of the plurality of transmitter-receiver pairs. The operations are further configured to generate a first inversion image based on the first set of measurement data, update a geological model based on the first inversion image, and control one or more operational parameters of the drilling system substantially in real-time based on the geological model.

The system of the preceding clause, wherein the operations are further configured to receive a second set of measurement data from the plurality of transmitter-receiver pairs after receiving the first set of measurement data, wherein the second set of measurement data includes a second portion of measurement data from each of the plurality of transmitter-receiver pairs at an overlapping measurement range. The operations are further configured to generate a second inversion image based on the second set of measurement data, compare the first inversion image and the second inversion image, update the geological model based on the second inversion image, and control the one or more operational parameters of the drilling system based on the geological model.

The system of any preceding clause, wherein the first portion of measurement data from each of the plurality of transmitter-receiver pairs at the earliest time interval is within a rear-facing window, and the second portion of measurement data from each of the plurality of transmitter-receiver pairs at the overlapping measurement range is within a center window.

A non-transitory, computer readable medium including instructions that, when executed by processing circuitry, cause the processing circuitry to perform operations configured to receive a first set of measurement data from a plurality of transmitter-receiver pairs of a measurement tool coupled to a drill string of a drilling system, wherein the first set of measurement data includes a first portion of measurement data from each of the plurality of transmitter-receiver pairs. The operations are further configured to generate a first inversion image based on the first set of measurement data, update a geological model based on the first inversion image, and control one or more operational parameters of the drilling system substantially in real-time based on the geological model.

The medium of the preceding clause, wherein the processing circuitry to perform operations configured to receive a second set of measurement data from the plurality of transmitter-receiver pairs after receiving the first set of measurement data, wherein the second set of measurement data includes a second portion of measurement data from each of the plurality of transmitter-receiver pairs at an overlapping measurement range. The operations are further configured to generate a second inversion image based on the second set of measurement data, compare the first inversion image and the second inversion image, update the geological model based on the second inversion image, and control the one or more operational parameters of the drilling system based on the geological model.

The medium of any preceding clause, wherein the first portion of measurement data from each of the plurality of transmitter-receiver pairs at the earliest time interval is within a rear-facing window, and the second portion of measurement data from each of the plurality of transmitter-receiver pairs at the overlapping measurement range is within a center window.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principals of the disclosure and its practical applications, to thereby enable others skilled in the art to best utilize the disclosure and various embodiments with various modifications as are suited to the particular use contemplated.

Finally, the techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function]. . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A method, comprising:
receiving a first set of measurement data from a plurality of transmitter-receiver pairs of a measurement tool coupled to a drill string of a drilling system, wherein the first set of measurement data includes a first portion of measurement data from each of the plurality of transmitter-receiver pairs;
generating a first inversion image based on the first set of measurement data;
updating a geological model based on the first inversion image; and
controlling one or more operational parameters of the drilling system substantially in real-time based on the geological model.

2. The method of claim 1, comprising:
receiving a second set of measurement data from the plurality of transmitter-receiver pairs after receiving the first set of measurement data, wherein the second set of measurement data includes a second portion of measurement data from each of the plurality of transmitter-receiver pairs at an overlapping measurement range;
generating a second inversion image based on the second set of measurement data;
updating the geological model based on the second inversion image; and
controlling the one or more operational parameters of the drilling system based on the geological model.

3. The method of claim 2, wherein the second inversion image has a higher quality than the first inversion image.

4. The method of claim 2, wherein the second portion of measurement data from each of the plurality of transmitter-receiver pairs at the overlapping measurement range is within a center window.

5. The method of claim 1, wherein each of the plurality of transmitter-receiver pairs has an axial spacing between a transmitter and a receiver, and the axial spacing varies between the plurality of transmitter-receiver pairs.

6. The method of claim 5, wherein the transmitter is shared by the plurality of transmitter-receiver pairs, and the transmitter is closer to a drill bit of the drill string than each receiver of the plurality of transmitter-receiver pairs.

7. The method of claim 6, wherein the plurality of transmitter-receiver pairs comprises a first transmitter-receiver pair, a second transmitter-receiver pair, and a third transmitter-receiver pair.

8. The method of claim 1, wherein the first portion of measurement data from each of the plurality of transmitter-receiver pairs is within a rear-facing window.

9. The method of claim 8, wherein the rear-facing window comprises a trapezoidal window.

10. The method of claim 8, wherein the rear-facing window extends rearwardly from a first point to a second point, the second point is offset rearwardly from the first point for each of the plurality of transmitter-receiver pairs, and the first point is representative of a real-time data point at an earliest time interval.

11. The method of claim 1, wherein the first set of measurement data comprise electromagnetic measurements, and the measurement tool comprises an electromagnetic measurement tool.

12. The method of claim 1, wherein updating the geological model based on the first inversion image comprises:
generating a geological model prediction based on the first set of measurement data;
comparing the first inversion image to the geological model prediction to obtain a comparison;
determining a similarity value based on the comparison;
upon determining the similarity value is below a similarity threshold, updating the geological model to:
discard the geological model prediction; and
generate an updated geological model prediction based on the first inversion image; and
upon determining the similarity value is above the similarity threshold, updating the geological model such that the geological model prediction is retained.

13. The method of claim 1, wherein generating the first inversion image comprises:
selecting one or more optimal channels from a set of channels, wherein the one or more optimal channels reduce redundancy of drilling data between each channel of the set of channels;
modifying the first set of measurement data based on one or more pre-processing operations to obtain modified measurement data;
selecting an inversion workflow to apply to the modified measurement data, wherein the inversion workflow comprises a one-dimensional (“1D”) inversion workflow, a two-dimensional (“2D”) inversion workflow, or a three-dimensional (“3D”) inversion workflow; and
applying the inversion workflow to the modified measurement data to generate the first inversion image.

14. The method of claim 13, comprising updating the inversion workflow based on the first inversion image, wherein the one or more pre-processing operations comprise window scheming operations, weighting operations, missing data handler operations, or any combination thereof.

15. A system, comprising:
a computing system comprising one or more processors, wherein the computing system is communicatively coupled with a drilling system;
a memory storing instructions that, when executed by the computing system, are configured to cause the computing system to perform operations configured to:
receive a first set of measurement data from a plurality of transmitter-receiver pairs of a measurement tool coupled to a drill string of a drilling system, wherein the first set of measurement data includes a first portion of measurement data from each of the plurality of transmitter-receiver pairs;
generate a first inversion image based on the first set of measurement data;
update a geological model based on the first inversion image; and
control one or more operational parameters of the drilling system substantially in real-time based on the geological model.

16. The system of claim 15, wherein the computing system is configured to perform operations configured to:
receive a second set of measurement data from the plurality of transmitter-receiver pairs after receiving the first set of measurement data, wherein the second set of measurement data includes a second portion of measurement data from each of the plurality of transmitter-receiver pairs at an overlapping measurement range;
generate a second inversion image based on the second set of measurement data;
compare the first inversion image and the second inversion image;
update the geological model based on the second inversion image; and
control the one or more operational parameters of the drilling system based on the geological model.

17. The system of claim 16, wherein the first portion of measurement data from each of the plurality of transmitter-receiver pairs at the earliest time interval is within a rear-facing window, and the second portion of measurement data from each of the plurality of transmitter-receiver pairs at the overlapping measurement range is within a center window.

18. A non-transitory, computer readable medium comprising instructions that, when executed by processing circuitry, cause the processing circuitry to perform operations configured to:
receive a first set of measurement data from a plurality of transmitter-receiver pairs of a measurement tool coupled to a drill string of a drilling system, wherein the first set of measurement data includes a first portion of measurement data from each of the plurality of transmitter-receiver pairs;
generate a first inversion image based on the first set of measurement data;
update a geological model based on the first inversion image; and
control one or more operational parameters of the drilling system substantially in real-time based on the geological model.

19. The medium of claim 18, wherein the processing circuitry to perform operations configured to:
receive a second set of measurement data from the plurality of transmitter-receiver pairs after receiving the first set of measurement data, wherein the second set of measurement data includes a second portion of measurement data from each of the plurality of transmitter-receiver pairs at an overlapping measurement range;
generate a second inversion image based on the second set of measurement data;
compare the first inversion image and the second inversion image;
update the geological model based on the second inversion image; and
control the one or more operational parameters of the drilling system based on the geological model.

20. The medium of claim 19, wherein the first portion of measurement data from each of the plurality of transmitter-receiver pairs at the earliest time interval is within a rear-facing window, and the second portion of measurement data from each of the plurality of transmitter-receiver pairs at the overlapping measurement range is within a center window.
